(19) United States
(12) Patent Application Publication
(10) Pub. No.: US 2006/0204823 A1
(43) Pub. Date: Sep. 14, 2006

(54) End assembly for an electrochemical cell stack

(75) Inventors: Antonio Gennaro Mazza, Whitby (CA); Nathaniel Ian Joos, Toronto (CA); David Frank, Toronto (CA)

Correspondence Address: BERESKIN AND PARR, 40 KING STREET WEST, BOX 401, TORONTO, ON, M5H 3Y2, CA

(73) Assignee: Hydrogenics Corporation, Mississauga (CA)

(21) Appl. No.: 11/073,679

(22) Filed: Mar. 8, 2005

(51) Int. Cl. H01M 8/02

(52) U.S. Cl. 429/38

(57) ABSTRACT

An end assembly for an electrochemical cell stack is described. The end assembly includes an end plate having an outer face facing away from the cell stack and an inner face opposite the outer face. Passageways in the end plate that terminate at openings on the inner face allow process fluids to pass through the end plate. Overmolding on a portion of the passageways act as a protective barrier.

### FIELD OF INVENTION

The present invention relates to end assemblies for an electrochemical cell stack.

### BACKGROUND OF THE INVENTION

Electrochemical cell stacks include fuel and electrolytic cell stacks. A fuel cell is an electrochemical device that produces an electromotive force by bringing a fuel (typically hydrogen gas) and an oxidant (typically air or oxygen gas) into contact with two suitable electrodes and an electrolyte. The fuel is introduced at a first electrode where it reacts electrochemically in the presence of the electrolyte to produce electrons and cations. The electrons are circulated from the first electrode to a second electrode via an electrical circuit. Cations pass through the electrolyte to the second electrode.

Simultaneously, the oxidant is introduced to the second electrode where the oxidant reacts electrochemically in presence of the electrolyte and catalyst, producing anions and consuming the electrons circulated through the electrical circuit; the cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode.

The half-cell reactions at the two electrodes are, respectively, as follows:
H2→2H++2e−
1/2O2+2H++2e−→H2O

The external electrical circuit withdraws electrical current and thus receives electrical power from the fuel cell. The overall fuel cell reaction produces electrical energy as shown by the sum of the separate half-cell reactions written above. Water and heat are typical by-products of the reaction.

Conceptually, electrolytic cells are fuel cells run in reverse, and share many of the same components as fuel stacks. In particular, a current is supplied to the electrolytic cell stack for the electrolysis of water into hydrogen and oxygen gases. In a fuel cell, hydrogen and oxygen are combined to produce water and release heat. In an electrolytic cell stack, energy is required to break up water into hydrogen and oxygen.

In practice, fuel cells are not operated as single units. Rather, fuel cells are connected in series, stacked one on top of the other, or placed side by side, to form what is usually referred to as a fuel cell stack. As used herein, the term “cell stack” includes the special case where just one fuel cell is present, although typically a plurality of fuel cells are stacked together to form a cell stack. The fuel and oxidant are directed through manifolds to the electrodes, while cooling is provided either by the reactants or by a cooling medium. Also within the stack are current collectors, cell-to-cell seals and insulation, with required piping and instrumentation provided externally of the fuel cell stack.

A fuel cell stack includes two end plates that sandwich components of the fuel cell stack. End plates provide integrity to the fuel cell stack by acting as an anchor for rods or bolts that are used to compress together various components of the cell stack resting between the end plates. Moreover, end plates can contain connection ports to which are attached fuel, oxidant and coolant ducts or hoses. These process fluids flow through the connection ports into and out of the fuel cells stack. In addition, end plates have components that insulate electrically conductive parts from parts meant to be non-conductive.

If components of the end assembly are not sufficiently protected from corrosive chemicals, several problems can arise. Particles, dissolved solids and/or flakes of the corroded material may be entrained by the process fluids and travel to components within the fuel cell. There, these particles, dissolved solids and/or flakes can cause degradation or malfunction of the fuel cell stack. Also, corrosion of the portions of the current collector plates that are in electrical contact with other components of the fuel cell stack can result in those portions exhibiting a higher electrical resistance, which can lead to less than ideal performance. Finally, corrosion can compromise the structural integrity of the fuel stack, potentially leading to collapse due to the compromised structural integrity of the stack components.

Consequently, any innovation that improves the anti-corrosive properties of components of an end assembly, while keeping the overall volume and weight of the end assembly manageable, would be highly desirable in the field of electrochemical cell stacks.

### SUMMARY OF THE INVENTION

Described herein is a system that employs overmolding as a protective barrier, both to prevent corrosion and to insulate. A judicious choice of areas on which overmolding is applied can lead to a reduction in the number of components required to fulfil the tasks associated with end assemblies. In particular, as described below in more detail, using overmolding according to the principles of the present invention can obviate the need for conventional insulator and current collector plates.

One embodiment of an end assembly for an electrochemical cell stack described herein includes an end plate having an outer face facing away from the cell stack and an inner face opposite the outer face. The end assembly also includes a current collector plate for collecting current. Overmolding disposed between the end plate and the current collector plate insulates the end plate from the current collector plate.

Also described herein is an end assembly for an electrochemical cell stack that includes an end plate having an outer face facing away from the cell stack and an inner face opposite the outer face. Passageways in the end plate that terminate at openings on the inner face allow process fluids to pass through the end plate. Overmolding on a portion of the passageways act as a protective barrier.

### BRIEF DESCRIPTION OF THE DRAWINGS

For a better understanding of the present invention, and to show more clearly how it may be carried into effect, reference will now be made, by way of example, to the accompanying drawings, which show preferred embodiments of the present invention and in which:

FIG. 1 shows an exploded perspective view of an electrochemical cell stack;

FIG. 2 shows a cross-sectional view of one embodiment of an end assembly for an electrochemical cell stack, according to the teachings of the present invention;

FIG. 3 shows a cross-sectional view of another embodiment of an end assembly for an electrochemical cell stack, according to the teachings of the present invention;

FIG. 4 shows a cross-sectional view of yet another embodiment of an end assembly for an electrochemical cell stack, according to the teachings of the present invention;

FIGS. 5A and 5B show a cross-sectional view and a plan view of yet another embodiment of an end assembly for an electrochemical cell stack, according to the teachings of the present invention;

FIG. 6A shows a cross-sectional view of a system for collecting current in an electrochemical cell stack, according to the teachings of the present invention; and

FIG. 6B shows a cross-sectional view, on an enlarged scale, of a fastening means of the system of FIG. 6A.

### DETAILED DESCRIPTION OF THE INVENTION

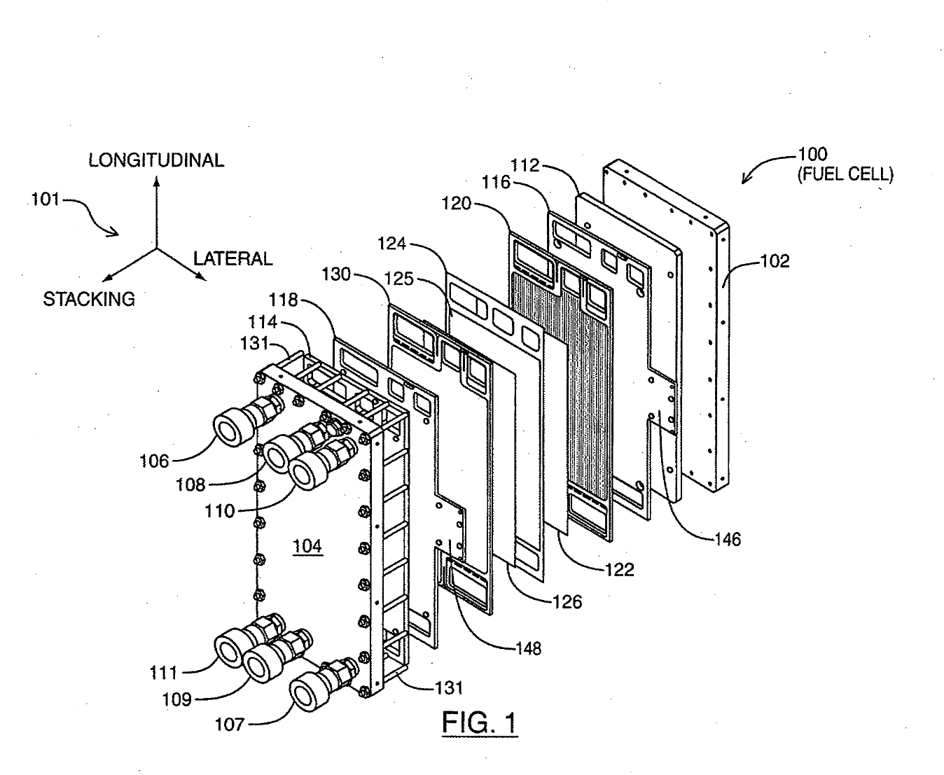

FIG. 1 shows an exploded perspective view of an electrochemical cell stack 100. A coordinate system 101, with stacking, longitudinal and lateral directions marked, is provided for convenient referencing. The fuel cell unit 100 includes an anode flow field plate 120, a cathode flow field plate 130 that sandwich a membrane electrode assembly (MEA) 124. Various sizes are possible for the plates 120 and 130. In one embodiment, for example, the short edge of the flow field plates 120, 130 is about 12 cm. Each plate 120 and 130 has an inlet region, an outlet region, and open-faced channels (not shown). The channels fluidly connect the inlet region to the outlet region, and provide a way for distributing the reactant gases to the outer surfaces of the MEA 124.

The MEA 124 comprises a solid electrolyte (i.e. a proton exchange membrane or PEM) 125 disposed between an anode catalyst layer (not shown) and a cathode catalyst layer (not shown). A first gas diffusion layer (GDL) 122 is disposed between the anode catalyst layer and the anode flow field plate 120, and a second GDL 126 is disposed between the cathode catalyst layer and the cathode flow field plate 130. The GDLs 122, 126 facilitate the diffusion of the reactant gas, either the fuel or oxidant, to the catalyst surfaces of the MEA 124. Furthermore, the GDLs enhance the electrical conductivity between each of the anode and cathode flow field plates 120, 130 and the membrane 125.

A first current collector plate 116 abuts against the rear face of the anode flow field plate 120, where the term “rear” indicates the side facing away from the MEA 124. Likewise, the term “front” refers to the side facing the MEA. A second current collector plate 118 abuts against the rear face of the cathode flow field plate 130. Each of the first and second current collector plates 116 and 118 respectively has a tab 146 and 148 protruding from the side of the fuel cell stack. First and second insulator plates 112 and 114 are located immediately adjacent the first and second current collector plates 116, 118, respectively. First and second end plates 102, 104 are located immediately adjacent the first and second insulator plates 112, 114, respectively. Pressure may be applied on the end plates 102, 104 to press the unit 100 together. Moreover, sealing means are usually provided between each pair of adjacent plates. Preferably, a plurality of tie rods 131 may also be provided. The tie rods 131 are screwed into threaded bores in the anode endplate 102 or can pass through plain bores in the anode endplate, and pass through corresponding plain bores in the cathode endplate 104. Fastening means, such as nuts, bolts, washers and the like are provided for clamping together the fuel cell unit 100

The end plate 104 is provided with a plurality of connection ports for the supply of various fluids. Specifically, the second endplate 104 has first and a second air connection ports 106, 107, first and second coolant connection ports 108, 109, and first and second hydrogen connection ports 110, 111. The ports 106-111 act as an interface between conduits such as tubing (not shown in FIG. 1) for carrying process fluids and the openings of the passageways on the outer face of the end plate 104. The MEA 124, the anode and cathode flow field plates 120, 130, the first and second current collector plates 116, 118, the first and second insulator plates 112, 114, and the first and/or second end plates 102, 104 have three inlets near one end and three outlets near the opposite end, which are in alignment to form fluid ducts for air as an oxidant, hydrogen as a fuel, and a coolant. Also, it is not essential that all the outlets be located at one end, i.e., pairs of flows could be counter current as opposed to flowing in the same direction. The inlet and outlet regions of each plate are also referred to as manifold areas. Although not shown, it will be understood that the various ports 106-111 are fluidly connected to ducts that extend along the stacking direction of the fuel cell unit 100.

In the fuel cell stack shown in FIG. 1, the fuel cell stack runs in “closed-end” mode, which means process fluids and coolant are supplied to and discharged from same end of the fuel cell stack. It should be understood that in other versions, the fuel cell may run in “flow-through” mode where process fluids and coolant enter the fuel cell stack from one end and leave the stack from the opposite end thereof. This requires the first end plate 102 be provided with corresponding connection ports for process fluids. It should also be understood that in practice it is useful to stack the several plates 130, 120 and MEAs 124 to form a fuel cell stack to produce a greater current output. Cell stacks may have more than one hundred MEAs 124.

End assemblies of conventional fuel cells, which include the end plates 102, 104, the insulator plates 112, 114 and the current collector plates 116, 118, suffer from several limitations that can give rise to corrosion and short circuits. In particular, process fluids can corrode the parts of the end assembly that come into contact with these fluids, notably, the fluid ducts that extend along the length of the fuel cell unit 100, and which allow the fluids to pass therethrough.

Corrosion can lead to several problems. Particles, dissolved solids and/or flakes of the corroded material may be entrained by the process fluids and travel to components within the fuel cell, such as the flow field plates 120 and 130. There, these particles, dissolved solids and/or flakes can cause degradation or malfunction of the fuel cell stack. Also, corrosion of the portions of the current collector plates that are in electrical contact with other components of the fuel cell stack can result in those portions exhibiting a higher electrical resistance, which can lead to less than ideal performance. Finally, corrosion can compromise the structural integrity of the fuel stack, potentially leading to collapse due to the compromised structural integrity of the stack components.

Short circuits and electrical hazards can also arise if the end plate assembly is not properly insulated. Properly functioning insulator plates 112 and 114 insulate the end plates 102 and 104 from the current collector plates 116 and 118. However, because process fluids are capable of carrying current, the end plates can become electrically charged by the process fluids. A dangerous electric shock could result if someone were to come into contact with such charged plates. In addition, the endplates are effectively electrically connected through the tie rods. In a situation where the stack is “open ended,” the stack may suffer some performance degradation through, what is known by those skilled in the art, shunt currents, which are effectively established between the end plates and through the process fluids contacting both end plates.

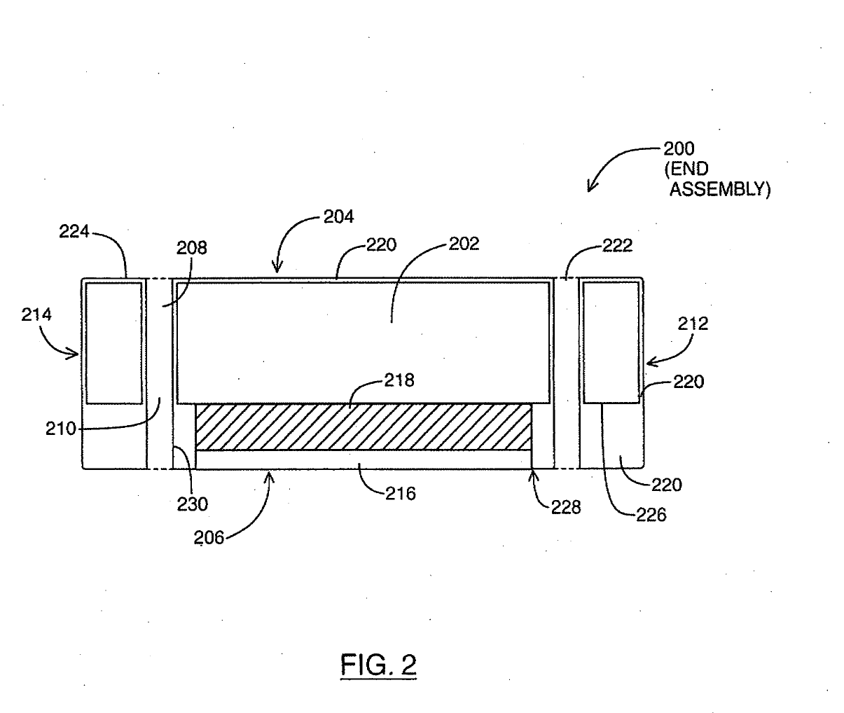

FIG. 2 shows a first embodiment of an end assembly 200 for an electrochemical cell stack that addresses some of the above-mentioned drawbacks of conventional fuel cells, according to principles of the present invention. The end assembly 200 includes an end plate 202 having an outer face 204 facing away from the cell stack and an inner face 206 opposite the outer face 204. Passageways 208 in the end plate 202 terminate at openings 210 on the inner face 206. These passageways 208 allow process fluids to pass through the end plate 202. An edge face 212 on a periphery 214 of the end plate 202 connects the inner face 206 to the outer face 204.

The end assembly 200 includes a current collector plate 216 for collecting current and an insulator plate 218 disposed between the current collector plate 216 and the inner face 206 to insulate the end plate 202 from the current collector plate 216.

The end assembly 200 further includes overmolding 220 on various parts of the end plate 202, such as on a portion or all of the passageways 208. As used herein, the term “overmolding” refers to a polymeric or elastomeric material that is injection or compression molded, or applied by any other means, over or around a compatible substrate using either insert or multi-shot processes.

The overmolding material may be any sufficiently nonconducting polymeric material, including elastomers. Examples are thermoset resins with or without reinforcement, thermoplastic resins with or without reinforcement, epoxy powder coatings, any conformal coating, such as parylene, silicones, fluorosilicones, etc. The thickness of the overmolding varies according to where it is disposed. In some embodiments, the overmolding can vary from 0.01 mm to the tens of millimetres.

The overmolding 220 serves as a protective barrier, both to prevent corrosion and to electrically insulate. For example, process fluids can normally corrode the passageways 208. By applying an overmolding, those portions of the passageways 208 covered therewith are protected from the corrosive process fluids.

Where the passageways 208 terminate at openings 222 on the outer face 204, overmolding 220 can be applied to areas 224 surrounding the openings 222, thereby protecting these areas 224 from the corrosive effects of the process fluids. In addition, overmolding 220 may be applied on a portion of the outer face 204 and edge face 212 as a protective barrier.

Overmolding 220 may also be applied on a portion of the inner face 206, which includes areas 226 surrounding the openings 210 on the inner face 206. This overmolding 220 on the areas 226 surrounding the openings 210 of the inner face 206 abuts the insulator plate 218 and the current collector plate 216 at an abutting plane 228 that is perpendicular to the longitudinal direction. The thickness of this overmolding (along the stacking direction) is substantially equal to the combined thickness of the insulator plate 218 and the current collector plate 216. The overmolding 220 is provided with passageways 230, aligned with the passageways 208 of the end plate 202, to allow process fluids to flow therethrough.

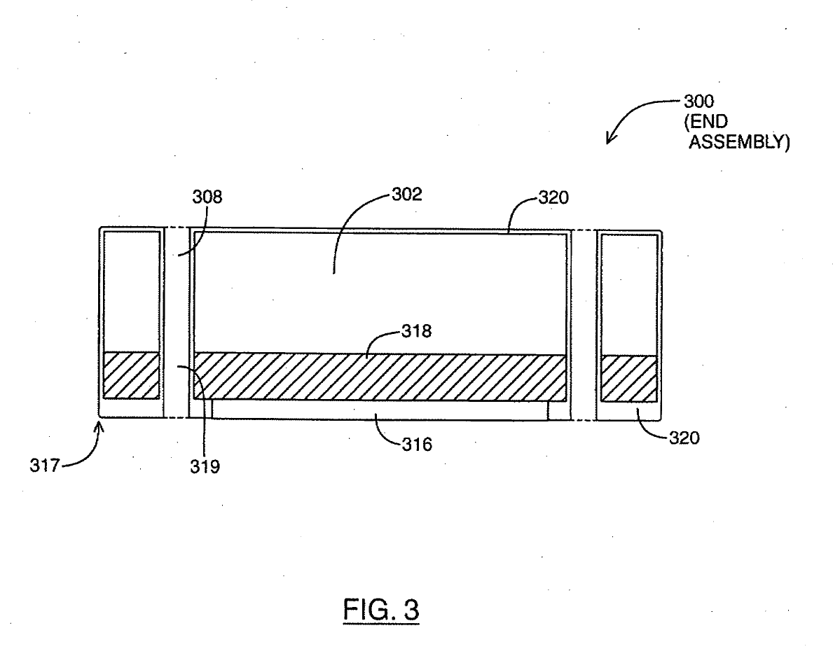

In a different embodiment of an end assembly 300 shown in FIG. 3, an insulator plate 318 is wider than the current collector plate 316, possibly extending along the longitudinal direction all the way to the edge 317 of the end plate 302. In such case, the insulator plate 318 would be provided with passageways 319, aligned with the passageways 308 of the end plate 302, to allow process fluids to flow therethrough. Overmolding 320 could then be applied continuously to the passageways in both the end plate 302 and insulator plate 318.

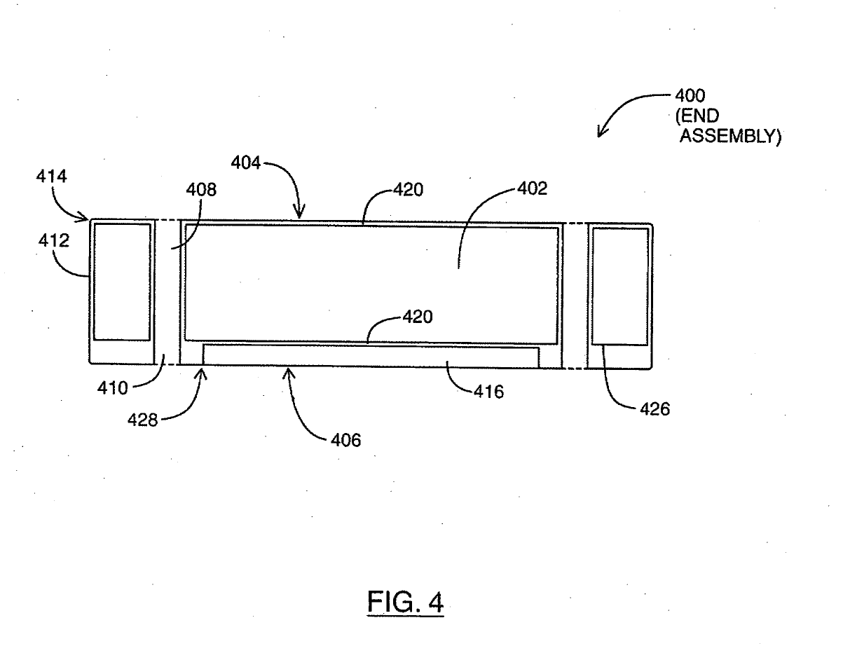

FIG. 4 shows another embodiment of an end assembly 400 for an electrochemical cell stack, in accordance with the present invention. The end assembly 400 includes an end plate 402 having an outer face 404 facing away from the cell stack and an inner face 406 opposite the outer face 404. Passageways 408 in the end plate 402 terminate at openings 410 on the inner face 406. These passageways 408 allow process fluids to pass through the end plate 402. An edge face 412 on a periphery 414 of the end plate 402, connects the inner face 406 to the outer face 404.

The end assembly 400 includes a current collector plate 416 for collecting current. The end assembly 400 further includes overmolding 420 on a portion of the inner face 406, the overmolding 420 disposed between the current collector plate 416 and the inner face 406 to insulate the end plate 402 from the current collector plate 416. Advantageously, the overmolding 420 so disposed obviates the need to have a conventional insulator plate to insulate the end plate 402 from the current collector plate 416.

The end assembly 400 further includes overmolding 420 on various parts of the end plate 402, such as on a portion of the passageways 408.

The overmolding 420 serves as a protective barrier, both to prevent corrosion and to electrically insulate. For example, process fluids can normally corrode the passageways 408. By applying an overmolding 420, those portions of the passageways 408 covered therewith are protected from the corrosive process fluids.

Overmolding 420 may also be applied on a portion of the inner face 406 that includes areas 426 surrounding the openings 410 on the inner face 406. This overmolding 420 on the areas 426 surrounding the openings 410 of the inner face 406 abuts the current collector plate 416 at an abutting plane 428, and has a thickness that is substantially equal to the thickness of the current collector plate 416.

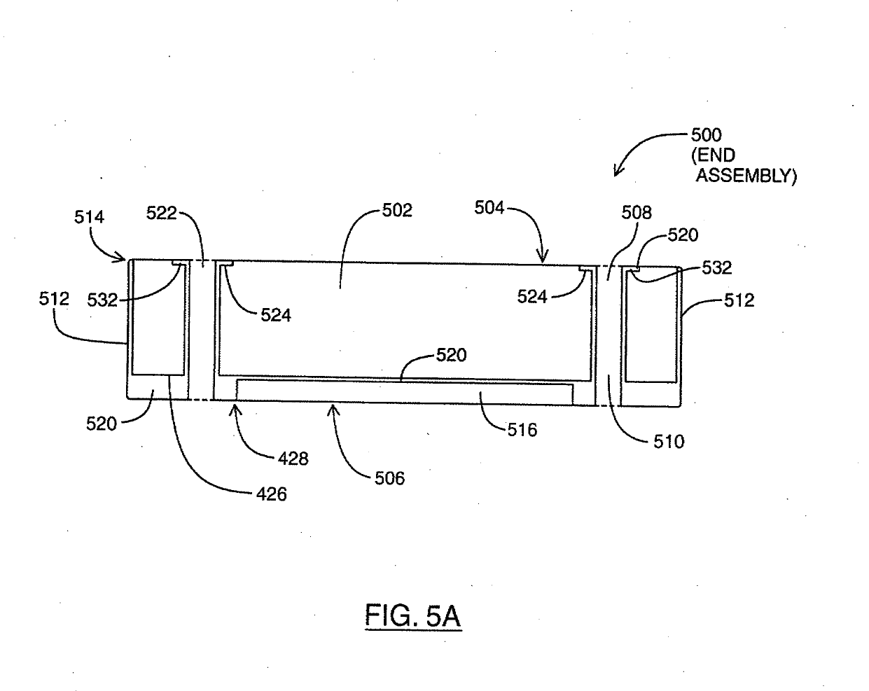

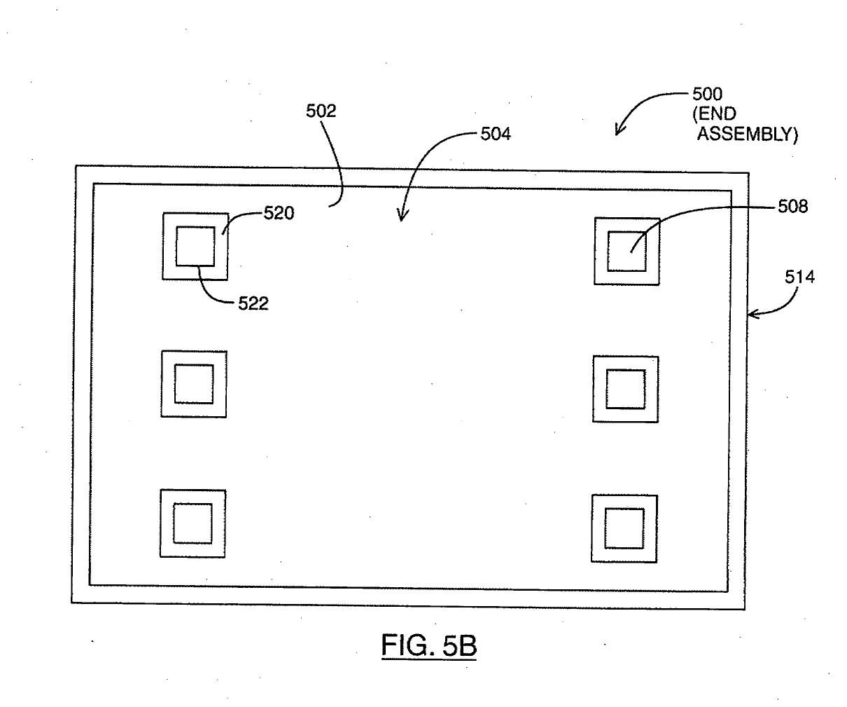

FIGS. 5A and 5B show cross-sectional and plan views of yet another embodiment of an end assembly 500 for an electrochemical cell stack, in accordance with the present invention. The end assembly 500 includes an end plate 502 having an outer face 504 facing away from the cell stack and an inner face 506 opposite the outer face 504. Passageways 508 in the end plate 502 terminate at openings 510 on the inner face 506. These passageways 508 allow process fluids to pass through the end plate 502. An edge face 512 on a periphery 514 of the end plate 502, connects the inner face 506 to the outer face 504.

The end assembly 500 includes a current collector plate 516 for collecting current. The end assembly 500 further includes overmolding 520 on a portion of the inner face 506, the overmolding 520 disposed between the current collector plate 516 and the inner face 506 to insulate the end plate 502 from the current collector plate 516. Advantageously, the overmolding 520 so disposed obviates the need to have a conventional insulator plate to insulate the end plate 502 from the current collector plate 516.

The end assembly 500 further includes overmolding 520 on various parts of the end plate 502, such as on a portion of the passageways 508.

Overmolding 520 may also be applied on a portion of the inner face 506 that includes areas 526 surrounding the openings 510 on the inner face 506. This overmolding 520 on the areas 526 surrounding the openings 510 of the inner face 506 abuts the current collector plate 516 at an abutting plane 528, and has a thickness that is substantially equal to the thickness of the current collector plate 516.

Where the passageways 508 terminate at openings 522 on the outer face 504, overmolding 520 can be applied to areas 524 surrounding the openings 522, thereby protecting these areas 524 from the corrosive effects of the process fluids. In one embodiment, the areas 624 surrounding the openings 522 are provided with indentations 532. Conveniently, the overmolding 520 can be applied within this indentation 532 to provide structural integrity.

Although in FIGS. 2-5 only one end assembly is shown, it should be understood that in an electrochemical cell stack such as the one shown in FIG. 1, two end assemblies are present. A first end assembly resides on one side of the flow field plate assembly containing the MEA, and anode and cathode field plates, and a second end assembly resides on an opposite side of the flow field plate assembly. It is consistent with the principles of the present invention to apply overmolding to one or both of the end assemblies.

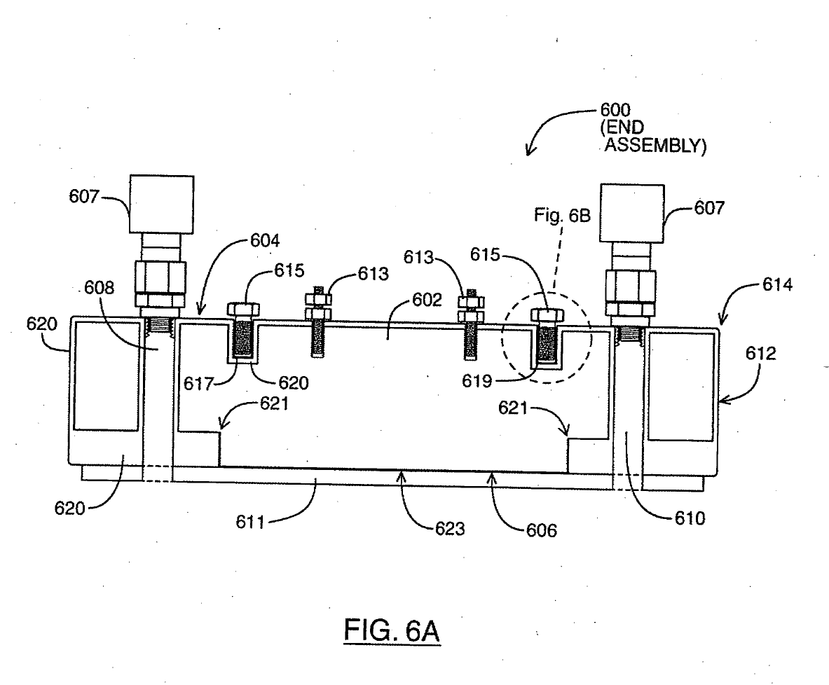

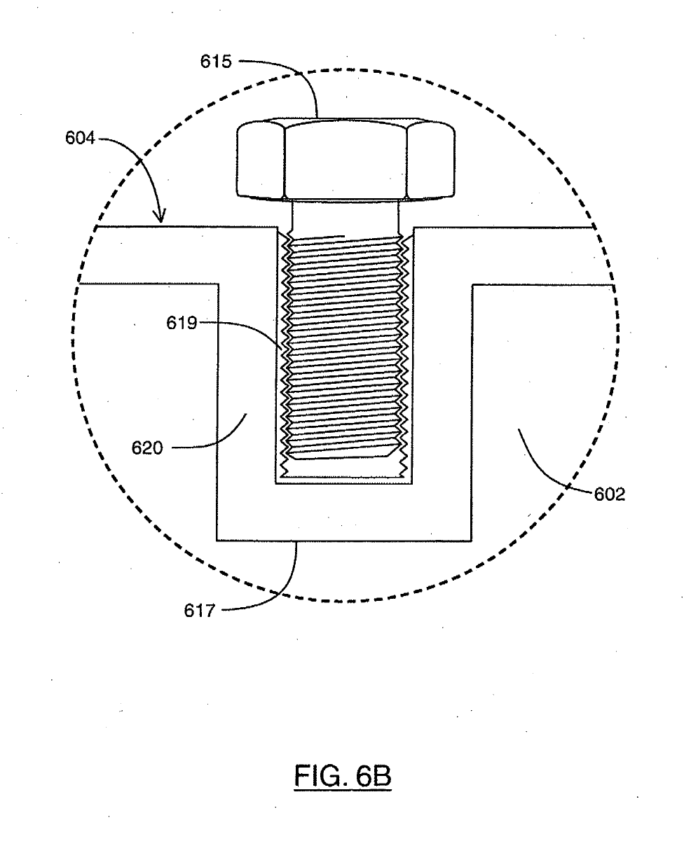

FIG. 6A shows a system 600 for collecting current in an electrochemical cell stack. The system 600 includes an end plate 602 having an outer face 604 facing away from the cell stack and an inner face 606 opposite the outer face 604. The system 600 further includes a plurality of connection ports 607 on the end plate 602 for the transmission of process fluids. These connection ports 607 can be attached in a number of ways, such as by screwing, snapping and welding. The connection ports 607 shown are attached to the outer face 604. In other embodiments, the connection ports 607 can instead or in addition be attached to the edge face 612, or the inner face 606. The passageways 608 are electrically isolated by virtue of the fact that the overmolding also extends to the inner surfaces of the passageways 608. A plurality of passageways 608 in the end plate 602 connects the connection ports 607 to openings 610 on the inner face 606. A flow field plate 611 is in electrical communication with the end plate 602 to allow current to flow therebetween.

In the embodiment shown in FIG. 6A, the end plate 602 abuts directly with the flow field plate 611 and serves as a current collector. At least one electrical terminal 613 is provided on the outer face 604, the electrical terminal 613 being in electrical communication with the end plate 602. The at least one terminal 613 may be connected to an electrical lead (not shown) to draw current. Advantageously, the end plate 602 acts as a current collector, thus obviating the need to have a separate current collector plate.

In the embodiment shown, current is collected by the inner face 606, which is in direct contact with the flow field plate 611. However, the end plate 602, while being in electrical communication with the flow field plate 611, need not be in direct contact therewith. In addition, current may also be collected by the edge face 612 or the outer face 604.

The system 600 can optionally include fastening means 615, such as screws, which can serve to fasten the electrochemical stack to a frame, for example. FIG. 6B shows an exploded view of such fastening means 615. A socket 617 in the end plate 602 is lined with overmolding 620. An anchor 619 is disposed within the socket 617 and the screw 615 can be screwed into the anchor 619. The overmolding 620 in the socket 617 insulates the anchor 619 and the screw 615 from the end plate 602 to ensure that the screw 615 does not carry current from the end plate 602. Such screws 615 can be used to fasten the electrochemical cell stack.

The system 600 further includes overmolding 620 on various parts of the end plate 602, such as on a portion of the passageways 608.

Overmolding 620 also surrounds the end plate 602, except for the area 623 abutting the flow field plate 611, and the electrical terminals 613. The overmolding 620 serves as a protective barrier both to prevent corrosion and to insulate. Advantageously, in the embodiment of FIGS. 6A and 6B, no conventional insulator plate need be included because the whole end plate 602 is the current collector plate, so there is not separate current collector plate to insulate from the end plate 602; the overmolding 620 serves to insulate the exterior parts of the end plate 602.

The inner face 606 has a pair of steps 621 running in the lateral direction near a periphery 614. Overmolding can be applied to these steps 621 to act as a protective barrier against corrosive process fluids.

The present invention is not limited to the embodiments shown or described above. For example, the end plate can be circular, oval and other shapes. Moreover, the shape of connection ports can vary. It is also to be understood that the present invention is not only applicable to fuel cell stacks, but is also applicable to end plates of other electrochemical cells, such as electrolytic cell stacks. In addition, although reference was made to a PEM fuel cell stack of FIG. 1, the principles of the present invention can be applied to other fuel cell types.

It is anticipated that those having ordinary skills in the art can make various modifications to the embodiments disclosed herein after learning the teaching of the present invention. For example, the number and arrangement of components in the system might be different, and different elements might be used to achieve the same specific function. However, these modifications should be considered to fall under the scope of the invention as defined in the following claims.

What is claimed is:

1. An end assembly for an electrochemical cell stack, the end assembly comprising
a) an end plate having an outer face facing away from the cell stack and an inner face opposite the outer face;
b) passageways in the end plate that terminate at openings on the inner face, the passageways allowing process fluids to pass through the end plate; and
c) overmolding on at least a portion of the passageways to act as a protective barrier.

2. The end assembly of claim 1, further comprising overmolding on a portion of the outer face to act as a protective barrier.

3. The end assembly of claim 2, wherein the passageways terminate at openings on the outer face, the portion of the outer face including areas surrounding the openings thereon, and wherein overmolding is provided on said portion of the outer face including the areas surrounding the openings.

4. The end assembly of claim 3, further comprising an edge face, the edge face being on a periphery of the end plate and connecting the inner face to the outer face, wherein the overmolding on the portion of the outer face extends to a portion of the edge face.

5. The end assembly of claim 4, wherein the outer face and the inner face are substantially rectangular.

6. The end assembly of claim 1, further comprising
a) a current collector plate; and
b) an insulator plate disposed between the current collector plate and the inner face to insulate the end plate from the current collector plate.

7. The end assembly of claim 6, further comprising overmolding on a portion of the inner face that includes areas surrounding the openings on the inner face, wherein the overmolding on the areas surrounding the openings of the inner face abuts the insulator plate and the current collector plate.

8. The end assembly of claim 7, wherein the overmolding on the areas surrounding the openings on the inner face has a thickness that is substantially equal to the combined thickness of the insulator plate and the current collector plate.

9. The end assembly of claim 8, further comprising overmolding on a portion of the outer face to act as a protective barrier.

10. The end assembly of claim 9, further comprising an edge face, the edge face being on a periphery of the end plate and connecting the inner face to the outer face, wherein the overmolding on the portion of the outer face extends to a portion of the edge face.

11. The end assembly of claim 10, where in the outer face and the inner face are substantially rectangular.

12. The end assembly of claim 1, further comprising
a) a current collector plate; and
b) overmolding on a portion of the inner face, the overmolding disposed between the current collector plate and the inner face to insulate the end plate from the current collector plate.

13. The end assembly of claim 12, further comprising overmolding on a portion of the outer face to act as a corrosion or electrical barrier.

14. The end assembly of claim 13, further comprising
a) an edge face, the edge face being on a periphery of the end plate and connecting the inner face to the outer face; and
b) overmolding on a portion of the edge face.

15. The end assembly of claim 14, wherein the overmolding on the portions of the outer, inner and edge faces form one continuous overmolding.

16. The end assembly of claim 15, wherein the outer face and the inner face are substantially rectangular, the edge face including two end faces, a bottom face and a top face.

17. An end assembly for an electrochemical cell stack, the end assembly comprising
a) an end plate having an outer face facing away from the cell stack and an inner face opposite the outer face;
b) a current collector plate for collecting current; and
c) overmolding disposed between the end plate and the current collector plate for insulating the end plate from the current collector plate.

18. The end assembly of claim 17, further comprising an edge face, the edge face being on a periphery of the end plate and connecting the inner face to the outer face, wherein the overmolding extends to a portion of the edge face.

19. The end assembly of claim 18, further comprising
a) passageways in the end plate that terminate at openings on the inner face, the passageways allowing process fluids to pass through the end plate; and
b) overmolding on a portion of the passageways to prevent corrosion.

20. The end assembly of claim 19, further comprising overmolding on a portion of the outer face to prevent corrosion, to insulate or both.

21. An end assembly for an electrochemical cell stack, the end assembly comprising
a) an end plate having
i) an outer face facing away from the cell stack,
ii) an inner face opposite the outer face, and
iii) an edge face, the edge face being on a periphery of the end plate and connecting the inner face to the outer face.
b) passageways in the end plate that terminate at openings on the inner face and openings on the outer face or edge face, the passageways allowing process fluids to pass through the end plate; and
c) overmolding on a portion of the outer face that includes areas surrounding at least one of the openings on the outer face and the openings on the edge face.

22. An electrochemical cell stack comprising
a) a flow field plate assembly including
i) an anode flow field plate,
ii) a cathode flow field plate, and
iii) a membrane electrode assembly disposed between the anode and cathode field plates for producing current; and
b) a first end assembly on one side of the flow field plate assembly and a second end assembly on an opposite side, at least one of the first end assembly and the second end assembly including
i) an end plate having an outer face facing away from the cell stack and an inner face opposite the outer face,
ii) passageways in the end plate that terminate at openings on the inner face, the passageways allowing process fluids to pass through the end plate, and
iii) overmolding on at least one of a portion of the end plate and a portion of the passageways to act as a protective barrier.
